(19) United States
(12) Patent Application Publication
(10) Pub. No.: US 2010/0189983 A1
(43) Pub. Date: Jul. 29, 2010

(54) PMMA/PVDF FILM WITH PARTICULARLY HIGH WEATHERING STABILITY AND HIGH UV PROTECTIVE ACTION

(75) Inventors: Uwe Numrich, Gross-Zimmern (DE); Achim Neuhaeuser, Mainz (DE); Thomas Arndt, Luetzelbach (DE); Thorsten Goldacker, Rossdorf (DE); Alexander Laschitsch, Frankfurt (DE); Guenther Dickhaut-Bayer, Riedstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/665,503

(22) PCT Filed: Mar. 17, 2008
(86) PCT No.: PCT/EP2008/053147

§ 371 Date: Dec. 18, 2009

(30) Foreign Application Priority Data
Jun. 22, 2007 (DE) 102007029263.7

(51) Int. Cl. B32B 27/08; C08L 27/14; C08K 5/3475; C08K 5/3492

(52) U.S. Cl. 428/220; 524/520; 428/421; 524/91; 524/100

(57) ABSTRACT

The invention describes a transparent foil composed of plastic with improved weathering resistance and increased intrinsic stability where the foil encompasses

a) poly(meth)acrylate and polyvinylidene fluoride in a ratio of from 1:0.01 to 1:1 (w/w); and

b) a mixture composed of UV stabilizers and of UV absorbers.

PMMA matrix plastics with high molecular weights and with a certain selected coacrylate proportion are preferably used in order to achieve excellent weathering resistance, and also improved intrinsic stability of the surface-protection foils.

### Field of the Invention

The invention relates to a transparent single- or multilayer (multi-sublayer) plastics foil, encompassing polymethyl (meth)acrylate (PMMA) and polyvinylidene fluoride (PVDF), in each case in at least one sublayer, or PMMA and PVDF in a mixture in at least one sublayer. The novel foil has particularly high UV resistance and has very high weathering resistance. The inventive foil is used by way of example as surface-protection foil for polyvinyl chloride (PVC) window profiles. The invention further relates to a process for the production of PMMA/PVDF foils with particularly high weathering resistance and high UV-protective action.

### PRIOR ART

Polymethyl (meth)acrylate has very high weathering resistance and is therefore particularly suitable for all applications in weathered outdoor sectors. For this reason, PMMA foils are well established in the market for use as surface-protection foils for coloured polyvinyl chloride (PVC) window profiles.

The finished profile must pass a requirements test set by the German RAL-Gütegemeinschaft, one of the provisions of this test being a test for weathering resistance. Although the weathering resistance of standard products available in the market, for example marketed as Plexiglas® colourless 99845 foil from Röhm GmbH, is shown to meet current requirements in long-term tests (an example being the ISO 4892-2 xenotest), it is capable of improvement.

Furthermore, there is rising demand for surface-protection foils whose weathering resistance markedly exceeds the current requirements. The foils currently obtainable in the market mostly use UV absorbers of benzotriazole type for resistance to UV radiation (wavelengths from 300 to 400 nm). These UV absorbers are by way of example marketed with trade mark Tinuvin P (2-(2′-hydroxy-5′-methylphenyl)benzotriazole) by Ciba Specialty Chemicals Inc. It is known that these UV absorbers undergo significant loss of their activity over a period of 10 years. The weathering-resistance foils equipped therewith first become matt, and this is followed by microcracking and then cracking. However, these UV absorbers also have advantageous properties: they are colour-neutral (low yellowness index), and have low volatility (important for the extrusion of the foils), and are inexpensive.

JP 2005-97351 (Mitsubishi Rayon) describes a foil composed of PMMA which has exceptional stability with respect to perfumes and compounds used in haircare and in hair cosmetics. The effect is achieved by the use of a mixture composed of UV absorbers whose melting point is not below 180° Celsius with a sterically hindered amine (HALS, hindered amine light stabilizer). Prime factors are the good ageing resistance of the foil when subject to thermal stress and its high solvent resistance. This foil is composed of a plurality of sublayers of different constitutions. The UV absorber can be either a benzotriazole or else a triazine. No advantages are described by the application with respect to weathering resistance.

JP-A 2004-338222 describes an acrylate foil with increased fluorescence duration. To this end, a foil is used which has been modified with a specific UV absorber and another foil is arranged above the foil and has been modified with a fluorescent dye. Fluorescent dyes are known to have little resistance to UV radiation. UV absorbers that can be used are benzotriazoles, triazoles and benzophenones or combinations of these absorbers. No positive effects have been disclosed on the intrinsic stability of the PMMA or on non-fluorescent colours.

EP 1 022 311 A1 describes an acrylic foil which retains solvent resistance with increased tensile strain at break and with improved resistance to haze on exposure to hot water. The increased tensile strain at break is intended to permit deformation of the foil without fracture even at very low bending radii and/or high deformation rates. To this end, a specific formulation is used including inter alia an acrylic-based thermoplastic component whose glass transition temperature is below or equal to 65° C. and whose average molecular weight is from 100 000 to 300 000.

Ciba company publications recommend combination of UV absorbers with HALS compounds for stabilization of PMMA.

Object

An object was to create a foil based on PMMA which is superior in terms of weathering resistance to the foil qualities available hitherto in the market. A particular intention is to improve stability over a prolonged period (>10 years=long-term stability). Stability means not only the intrinsic stability of the foil with respect to UV effects and weathering effects but also stability of UV-protective action (discernible by way of example from the stability of the colour locus of a colour layer covered with the protective foil).
A further intention is that a UV package having maximum colour-neutrality be used to stabilize the increased-stability foil.
Another intention is that the individual components for the production of the foil cause minimum gas evolution during processing in an extrusion plant.
The intention is to minimise the cost of the additives used to stabilize the foil, and also to minimise the cost of the entire foil.
The intention is to permit the migration of one or more components of the UV package to the surface of the foil.
The intention is to maximise the wavelength spectrum covered (from 300 nm-400 nm).
The intention is that the foil be substantially free from stress-whitening.
The components used are intended to permit cost-effective operation of an extrusion plant.
The foil is intended to have excellent weathering resistance.
The foil is intended to have very good chemicals resistance, for example with respect to commercially available cleaning compositions.
The foil is intended to have dirt-repellent properties, to ease cleaning.

Achievement of object

A foil with all of the features of the independent product claim achieves the objects discussed above, and also achieves other objects which, although not individually mentioned, are readily derivable by the person skilled in the art from the discussion in the introduction. Preferred embodiments of the inventive foil are provided by the claims dependent on the independent product claim. The independent process claim protects a process for the production of the inventive foil. Preferred modifications of the process are found in the dependent process claims. Finally, the use claims disclose preferred application sectors for the inventive foil.

The existence of a foil composed of plastic and encompassing
a) poly(meth)acrylate and polyvinylidene fluoride in a ratio of from 1:0.01 to 1:1 (w/w); and
b) a mixture composed of UV stabilizers and of UV absorbers

permits, in a manner not readily foreseeable by the person skilled in the art, provision of a transparent foil providing improved weathering resistance and increased intrinsic stability, and also moreover having a number of further advantages. Among these are
Improved weathering resistance in comparison with foil qualities hitherto available in the market.
Improved long-term weathering resistance.
Improved intrinsic stability of the foil with respect to UV effects and weathering effects.
Improved stability of UV-protective action (discernible by way of example from the stability of the colour locus of a colour layer covered with the protective foil).
High colour-neutrality of the stable foil inter alia because of an extremely colour-neutral UV package.
Advantageous processing properties during extrusion, since the individual components for production of the foil cause extremely little, or no, gas evolution during processing in an extrusion plant.
The additives used for stabilization of the foil are inexpensive.
The entire foil is very inexpensive.
Migration of one or more components of the UV package to the surface of the foil is possible.
Maximum width of wavelength spectrum (from 300 nm-400 nm) is covered.
The foil is free from stress-whitening.

With regard to the process, the objects underlying the invention are firstly achieved by a process for the production of a transparent foil composed of plastic providing increased weathering resistance and improved intrinsic stability, in which process

a foil is moulded in a foil-moulding process, preferably in the chill-roll process known per se from a composition encompassing

a) poly(meth)acrylate and polyvinylidene fluoride in a ratio of from 1:0.01 to 1:1 (w/w);

and

b) a mixture composed of UV stabilizers and of UV absorbers.

Secondly, the objects underlying the invention are achieved in respect of process technology by a process for the production of a transparent multi-sublayer foil composed of plastic with increased weathering resistance and with improved intrinsic stability,

in which process

a poly(meth)acrylate foil and a polyvinylidene fluoride foil are coextruded or laminated to one another, where one or both of the foils comprise(s) a mixture composed of UV stabilizers and of UV absorbers, or where one of the foils comprises at least one UV stabilizer and the other foil comprises at least one UV absorber, and where the laminated or coextruded multi-sublayer foil comprises the poly(meth)acrylate and polyvinylidene fluoride in a ratio of from 1:0.01 to 1:1 (w/w).

The PMMA/PVDF foil obtained can therefore be a single-sublayer foil (first variant of the process) or a multi-sublayer foil (second variant of the process), and all of the advantages mentioned here for the product are achievable in both variants.

With respect to the use of the product, the inventive PMMA/PVDF foils can be used particularly advantageously for the coating of plastics mouldings.

The PMMA/PVDF foils of the invention here are advantageously used for the design of a high-specification, durable surface finish for substrate materials.

Working of the Invention

Preparation of the PMMA Plastics

Polymethyl methacrylate plastics are generally obtained by free-radical polymerization of mixtures which comprise methyl methacrylate. These mixtures generally comprise at least 40% by weight, preferably at least 60% by weight and particularly preferably at least 80% by weight, based on the weight of the monomers, of methyl methacrylate.

These mixtures for production of polymethyl methacrylates can also comprise other (meth)acrylates copolymerizable with methyl methacrylate. The expression (meth)acrylates comprises methacrylates and acrylates and mixtures of the two. These monomers are well known. Among them are, inter alia, (meth)acrylates which derive from saturated alcohols, e.g. methyl acrylate, ethyl (meth)acrylate, propyl (meth)acrylate, n-butyl (meth)acrylate, tert-butyl (meth)acrylate, isobutyl (meth)acrylate, pentyl (meth)acrylate and 2-ethylhexyl (meth)acrylate; and also (meth)acrylates which derive from unsaturated alcohols, e.g. oleyl (meth)acrylate, 2-propynyl (meth)acrylate, allyl (meth)acrylate, vinyl (meth)acrylate; and also aryl (meth)acrylates, such as benzyl (meth)acrylate or phenyl (meth)acrylate, and in each case the aryl radicals here can be unsubstituted or can have up to four substituents; cycloalkyl (meth)acrylates, such as 3-vinylcyclohexyl (meth)acrylate, bornyl (meth)acrylate; hydroxyalkyl (meth)acrylates, such as 3-hydroxypropyl (meth)acrylate, 3,4-dihydroxybutyl (meth)acrylate, 2-hydroxyethyl (meth)acrylate, 2-hydroxypropyl (meth)acrylate; glycol di(meth)acrylates, such as 1,4-butanediol (meth)acrylate, (meth)acrylates of ether alcohols, e.g. tetrahydrofurfuryl (meth)acrylate, vinyloxyethoxyethyl (meth)acrylate; amides and nitriles of (meth)acrylic acid, e.g. N-(3-dimethylaminopropyl)(meth)acrylamide, N-(diethylphosphono)(meth)acrylamide, 1-methacryloylamido-2-methyl-2-propanol; sulphur-containing methacrylates, such as ethylsulphinylethyl (meth)acrylate, 4-thiocyanatobutyl (meth)acrylate, ethylsulphonylethyl (meth)acrylate, thiocyanatomethyl (meth)acrylate, methyl-sulphinylmethyl (meth)acrylate, bis((meth)acryloyloxyethyl) sulphide; polyfunctional (meth)acrylates, such as trimethyloylpropane tri(meth)acrylate.

Free-Radical Initiators

The polymerization reaction is generally initiated by known free-radical initiators. Among the preferred initiators are, inter alia, the azo initiators well known to persons skilled in the art, e.g. AIBN and 1,1-azobiscyclohexanecarbonitrile, and peroxy compounds, such as methyl ethyl ketone peroxide, acetylacetone peroxide, dilauryl peroxide, tert-butyl 2-ethylperhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butyl 2-ethylperoxyhexanoate, tert-butyl 3,5,5-trimethylperoxyhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another and mixtures of the abovementioned compounds with compounds that have not been mentioned but which can likewise form free radicals.

Other Monomers

The compositions to be polymerized can comprise not only the (meth)acrylates described above but also other unsaturated monomers which are copolymerizable with methyl methacrylate and with the abovementioned (meth)acrylates. Among these are, inter alia, 1-alkenes, such as 1-hexene, 1-heptene; branched alkenes, such as vinylcyclohexane, 3,3-dimethyl-1-propene, 3-methyl-1-diisobutylene, 4-methyl-1-pentene; acrylonitrile; vinyl esters, such as vinyl acetate; styrene, substituted styrenes having an alkyl substituent in the side chain, e.g. α-methylstyrene and α-ethylstyrene, substituted styrenes having an alkyl substituent on the ring, e.g. vinyltoluene and p-methylstyrene, halogenated styrenes, such as monochlorostyrenes, dichlorostyrenes, tribromostyrenes and tetrabromostyrenes; heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles; vinyl ethers and isoprenyl ethers; maleic acid derivatives, such as maleic anhydride, methylmaleic anhydride, maleimide, methylmaleimide; and dienes, such as divinylbenzene.

The amount generally used of these comonomers is from 0% by weight to 60% by weight, preferably from 0% by weight to 40% by weight and particularly preferably from 0% by weight to 20% by weight, based on the weight of monomers, and the compounds here can be used individually or in the form of a mixture.

Further preference is given to a foil using a poly(meth)acrylate which is obtainable by polymerization of a composition having, as polymerizable constituents:

a. from >50% by weight to 99.9% by weight of methyl methacrylate,

b. from 0.1% by weight to <50% by weight of an acrylate having an ester radical deriving from a C1-C4 alcohol,

c. from 0% by weight to 10% by weight of monomers copolymerizable with the monomers a. and b.

Further preference is given to a foil using a poly(meth)acrylate which is obtainable by polymerization of a composition having, as polymerizable constituents:

a. from 88% by weight to 92% by weight of methyl methacrylate,

b. from 8% by weight to 12% by weight of an acrylate having an ester radical deriving from a C1-C4 alcohol,

c. from 0% by weight to 10% by weight of monomers copolymerizable with the monomers a. and b.

Surprisingly, it has been found that use of a coacrylate proportion in the range from 8 to 12 per cent by weight, preferably using that amount of an n-butyl acrylate, raises the intrinsic stability of the foil markedly beyond the extent hitherto known. This had not therefore been readily foreseeable. As the coacrylate proportion selected increases, the stability of the foil increases. Furthermore, an increase beyond the limiting values is in turn disadvantageous, since the additional proportions of coacrylate do not bring about any significant addition of suppression of cracking.

Regulator

The chain lengths of the polymers can be adjusted by polymerization of the monomer mixture in the presence of molecular-weight regulators, particular examples being the mercaptans known for this purpose, e.g. n-butyl mercaptan, n-dodecyl mercaptan, 2-mercaptoethanol or 2-ethylhexyl thioglycolate, or pentaerythritol tetrathioglycolate; the amounts generally used of the molecular-weight regulators being from 0.05 to 5% by weight, based on the monomer mixture, preference being given to amounts of from 0.1 to 2% by weight and particular preference being given to amounts of from 0.2 to 1% by weight, based on the monomer mixture (cf. by way of example H. Rauch-Puntigam, Th. Völker, “Acryl- and Methacrylverbindungen” [“Acrylic and Methacrylic Compounds”], Springer, Heidelberg, 1967; Houben-Weyl, Methoden der organischen Chemie, [Methods of Organic Chemistry], Vol. XIV/1, page 66, Georg Thieme, Heidelberg, 1961, or Kirk-Othmer, Encyclopedia of Chemical Technology, Vol. 1, pages 296 et seq., J. Wiley, New York, 1978).

Impact-Modified Poly(meth)acrylate Plastic

The poly(meth)acrylate a) has preferably been rendered impact-resistant by using an impact modifier.

In one preferred variant, the amount of impact modifier is from 1% to 50% by weight, based on the entirety of poly(meth)acrylate and impact modifier.

In another preferred variant, the impact-modified poly(meth)acrylate plastic is composed of from 20% by weight to 80% by weight, preferably from 30% by weight to 70% by weight, of a poly(meth)acrylate matrix and of from 80% to 20% by weight, preferably from 70% by weight to 30% by weight, of elastomer particles whose average particle diameter is from 10 to 150 nm (measurements by way of example using the ultracentrifuge method).

The poly(meth)acrylate a) and the impact modifier are preferably derived from a core-shell polymer, where the shell forms a matrix composed of polymer in the subsequent foil.

The elastomer particles dispersed in the poly(meth)acrylate matrix preferably have a core using a soft elastomer phase and using a hard phase bonded thereto.

The impact-modified poly(meth)acrylate plastic (imPMMA) is composed of a proportion of matrix polymer, polymerized from at least 80% by weight of units of methyl methacrylate, and also, if appropriate, from 0% by weight to 20% by weight of units of monomers copolymerizable with methyl methacrylate, and of a proportion of impact modifiers based on crosslinked poly(meth)acrylates and dispersed in the matrix.

The matrix polymer is composed in particular of from 80% by weight to 100% by weight, preferably from 90% by weight to 99.5% by weight, of methyl methacrylate units capable of free-radical polymerization and, if appropriate, from 0% by weight to 20% by weight, preferably from 0.5% by weight to 12% by weight, of further comonomers capable of free-radical polymerization, e.g. C₁-C₄-alkyl(meth)acrylates, in particular methyl acrylate, ethyl acrylate or butyl acrylate. As the molecular weight of the matrix polymers increases, the weathering resistance of the UV-protection foil improves.

In one particular embodiment of the invention, the foil is characterized by a weight-average molar mass M_{w} of the poly(meth)acrylate of ≧80 000 g/mol, determined by means of gel permeation chromatography (GPC). The weight-average molar mass M_{w} of the poly(meth)acrylate is more preferably ≧120 000 g/mol, determined likewise by means of gel permeation chromatography (GPC). For the purposes of the invention, it is possible to achieve foils of even greater weathering resistance if the weight-average molar mass M_{w} of the poly(meth)acrylate is 140 000 g/mol, determined by means of gel permeation chromatography (GPC). The average (weight-average) molar mass M_{w} of the matrix is generally in the range from 80 000 g/mol to 200 000 g/mol (M_{w} being determined by means of gel permeation chromatography with reference to polymethyl methacrylate as calibration standard, as for all of the M_{w} determinations on the matrix PMMA). However, particularly good weathering resistances are obtained from foils whose matrix polymer has an average molar mass M_{w} (weight-average) in the range from 80 000 g/mol to 180 000 g/mol, preferably in the range from 108 000 g/mol to 180 000 g/mol, more preferably in the range from 122 000 g/mol to 180 000 g/mol, in each case determined by means of GPC against PMMA calibration standards. An example of another method for determination of the molar mass M_{w}, alongside the GPC method, is a light-scattering method (see, for example, H. F. Mark et al., Encyclopedia of Polymer Science and Engineering, 2nd Edition, Vol. 10, pages 1 et seq., J. Wiley, 1989).

Preference is given to a copolymer composed of from 85% by weight to 99.5% by weight of methyl methacrylate and from 0.5% by weight to 15% by weight of methyl acrylate, which, if appropriate, has an optional proportion of from 0-12% by weight of butyl acrylate, the amounts here being based on 100% by weight of the polymerizable constituents. Particularly advantageous copolymers are those obtainable by copolymerization of from 90% by weight to 99.5% by weight of methyl methacrylate and from 0.5% by weight to 10% by weight of methyl acrylate, which, if appropriate, has an optional proportion of from 0% by weight to 10% by weight of butyl acrylate, where the amounts are based on 100% by weight of the polymerizable constituents. More preference is given to copolymers which are obtainable from 92.5% by weight to 97.5% by weight of methyl methacrylate and from 2.5% by weight to 7.5% by weight of methyl acrylate which, if appropriate, has an optional proportion of from 0% by weight to 7% by weight of butyl acrylate, where the amounts are based on 100% by weight of the polymerizable constituents. The Vicat softening points VSP (ISO 306-B50) can be in the region of at least 90° C., preferably from 95° C. to 112° C.

The impact modifier and matrix polymer can be mixed in the extruder in the melt to give impact-modified polymethacrylate moulding compositions. The material discharged is generally first chopped to give pellets. These can be further processed by means of extrusion or injection moulding to give mouldings, such as sheets, foils or injection-moulded parts.

The Impact Modifier

The polymethacrylate matrix comprises an impact modifier which by way of example can be a core-shell polymer having a two- or three-shell structure, preference being given to use of two-shell impact modifiers.

Impact modifiers for polymethacrylate plastics are well known. EP-A 0 113 924, EP-A 0 522 351, EP-A 0 465 049 and EP-A 0 683 028 describe by way of example the preparation and structure of impact-modified polymethacrylate moulding compositions.

From 1% by weight to 35% by weight, preferably from 2% by weight to 20% by weight, particularly preferably from 3% by weight to 15% by weight, in particular from 5% by weight to 12% by weight, of an impact modifier which is an elastomer phase composed of crosslinked polymer particles is present in the polymethacrylate matrix. The impact modifier is obtained in a manner known per se by bead polymerization or by emulsion polymerization.

In the simplest case materials involved are crosslinked particles obtained by means of bead polymerization whose average particle size is in the range from 10 nm to 150 nm, preferably from 20 nm to 100 nm, in particular from 30 nm to 90 nm. These are generally composed of at least 40% by weight, preferably from 50% by weight to 70% by weight, of methyl methacrylate, from 20% by weight to 40% by weight, preferably from 25% by weight to 35% by weight, of butyl acrylate, and from 0.1% by weight to 2% by weight, preferably from 0.5% by weight to 1% by weight, of a crosslinking monomer, e.g. a polyfunctional (meth)acrylate, e.g. allyl methacrylate and, if appropriate, other monomers, e.g. from 0% by weight to 10% by weight, preferably from 0.5% by weight to 5% by weight, of C₁-C₄-alkyl methacrylates, such as ethyl acrylate or butyl methacrylate, preferably methyl acrylate, or other vinylically polymerizable monomers, e.g. styrene.

Preferred impact modifiers are polymer particles which can have a two- or three-layer core-shell structure and are obtained by emulsion polymerization (see, for example, EP-A 0 113 924, EP-A 0 522 351, EP-A 0 465 049 and EP-A 0 683 028). However, the invention requires suitable particle sizes of these emulsion polymers in the range from 10 nm to 150 nm, preferably from 20 nm to 120 nm, particularly preferably from 50 nm to 100 nm.

A three-layer or three-phase structure with a core and two shells can be created as follows. The innermost (hard) shell can, for example, be composed in essence of methyl methacrylate, of small proportions of comonomers, e.g. ethyl acrylate, and of a proportion of crosslinking agent, e.g. allyl methacrylate. The middle (soft) shell can, for example, be composed of butyl acrylate and, if appropriate, styrene, while the outermost (hard) shell is in essence the same as the matrix polymer, thus bringing about compatibility and good linkage to the matrix. The proportion of polybutyl acrylate in the impact modifier is decisive for the impact-modifying action and is preferably in the range from 20% by weight to 40% by weight, particularly preferably in the range from 25% by weight to 35% by weight.

Two-phase impact modifier according to EP 0 528 196 A1

Preference is given, in particular for foil production, but not restricted thereto, to use of a system known in principle from EP 0 528 196 A1 which is a two-phase impact-modified polymer composed of:
a1) from 10% by weight to 95% by weight of a coherent hard phase whose glass transition temperature T_{mg} is above 70° C., composed of
   a11) from 80% by weight to 100% by weight (based on a1) of methyl methacrylate and
   a12) from 0% by weight to 20% by weight of one or more other ethylenically unsaturated monomers capable of free-radical polymerization, and
a2) from 90% by weight to 5% by weight of a tough phase whose glass transition temperature T_{mg} is below −10° C., distributed in the hard phase and composed of
   a21) from 50% by weight to 99.5% by weight of a C₁-C₁₀-alkyl acrylate (based on a2)
   a22) from 0.5% by weight to 5% by weight of a crosslinking monomer having two or more ethylenically unsaturated radicals which are capable of free-radical polymerization, and
   a23) if appropriate other ethylenically unsaturated monomers capable of free-radical polymerization,

where at least 15% by weight of the hard phase a1) has covalent linkage to the tough phase a2).

The two-phase impact modifier can be produced by a two-stage emulsion polymerization reaction in water, as described by way of example in DE-A 38 42 796. In the first stage, the tough phase a2) is produced and is composed of at least 50% by weight, preferably more than 80% by weight, of lower alkyl acrylates, thus giving a glass transition temperature T_{mg} below −10° C. for this phase. Crosslinking monomers a22) used comprise (meth)acrylates of diols, e.g. ethylene glycol dimethacrylate or 1,4-butanediol dimethacrylate, aromatic compounds having two vinyl or allyl groups, e.g. divinylbenzene, or other crosslinking agents having two ethylenically unsaturated radicals which are capable of free-radical polymerization, e.g. allyl methacrylate, as graft-linking agent. Crosslinking agents that may be mentioned by way of example and have three or more unsaturated groups which are capable of free-radical polymerization, e.g. allyl groups or (meth)acrylic groups, are triallyl cyanurate, trimethylolpropane triacrylate and trimethylolpropane trimethacrylate, and pentaerythrityl tetraacrylate and pentaerythrityl tetramethacrylate. U.S. Pat. No. 4,513,118 gives other examples in this connection.

The ethylenically unsaturated monomers capable of free-radical polymerization and mentioned under a23) can, by way of example, be acrylic or methacrylic acid or else their alkyl esters having from 1 to 20 carbon atoms but not mentioned above, and the alkyl radical here can be linear, branched or cyclic. Furthermore, a23) can comprise further aliphatic comonomers which are capable of free-radical polymerization and which are copolymerizable with the alkyl acrylates a21). However, the intention is to exclude significant proportions of aromatic comonomers, such as styrene, alpha-methylstyrene or vinyltoluene, since they lead to undesired properties of the moulding composition—especially on weathering.

When the tough phase is produced in the first stage, careful attention has to be paid to the setting of the particle size and its polydispersity. The particle size of the tough phase here is in essence dependent on the concentration of the emulsifier. The particle size can advantageously be controlled by the use of a seed latex. Particles whose average (weight-average) particle size is below 130 nm, preferably below 70 nm, and whose particle-size polydispersity P₈₀ is below 0.5 (P₈₀ being determined from cumulative evaluation of the particle-size distribution determined by ultracentrifuge; the relationship is: P₈₀=[(r₉₀-r₁₀d/r₅₀]−1, where r₁₀, r₅₀, r₉₀=average cumulative particle radius, being the value which is greater than 10, 50, 90% of the particle radii and is smaller than 90, 50, 10% of the particle radii), preferably below 0.2, are achieved using emulsifier concentrations of from 0.15 to 1.0% by weight, based on the aqueous phase. This applies especially to anionic emulsifiers, examples being the particularly preferred alkoxylated and sulphated paraffins. Examples of polymerization initiators used are from 0.01% by weight to 0.5% by weight of alkali metal peroxodisulphate or ammonium peroxodisulphate, based on the aqueous phase, and the polymerization reaction is initiated at temperatures of from 20 to 100° C. Preference is given to use of redox systems, an example being a combination composed of from 0.01% by weight to 0.05% by weight of organic hydroperoxide and from 0.05 to 0.15% by weight of sodium hydroxymethylsulphinate, at temperatures of from 20 to 80° C.

The glass transition temperature of the hard phase a1) of which at least 15% by weight has covalent bonding to the tough phase a2) is at least 70° C. and this phase can be composed exclusively of methyl methacrylate. Up to 20% by weight of one or more other ethylenically unsaturated monomers which are capable of free-radical polymerization can be present as comonomers a12) in the hard phase, and the amount of alkyl (meth)acrylates used here, preferably alkyl acrylates having from 1 to 4 carbon atoms, is such that the glass transition temperature is not below the glass transition temperature mentioned above.

The polymerization of the hard phase a1) proceeds likewise in emulsion in a second stage, using the conventional auxiliaries, for example those also used for polymerization of the tough phase a2).

PVDF Polymers

The PVDF polymers used for the purposes of the invention are polyvinylidene fluorides, these generally being transparent, semicrystalline, thermoplastic fluoroplastics. The fundamental unit for polyvinylidene fluoride is vinylidene fluoride, which is reacted (polymerized) by means of a specific catalyst to give polyvinylidene fluoride in high-purity water under controlled conditions of pressure and of temperature. Vinylidene fluoride is in turn obtainable by way of example from hydrogen fluoride and methylchloroform as starting materials, by way of chlorodifluoroethane as precursor. For the purposes of the invention it is possible in principle to obtain good success by using any commercial grade of PVDF. Among these are Kynar® grades produced by Arkema, Dyneon® grades produced by Dyneon, and also Solef® grades produced by Solvay.

An extremely high-performance weathering-protection foil can be obtained by using the combination of PMMA/PVDF in an inventive foil in the inventive range of amounts of poly(meth)acrylate and polyvinylidene fluoride in a ratio of from 1:0.01 to 1:1 (w/w), in conjunction with the inventive UV stabilizer and UV absorber package.

In one preferred variant, the inventive foil is a single-layer foil. This low-cost variant features a blend of PMMA and PVDF in a single layer.

These embodiments are of very particular interest as single-layer weathering-protection foil. Further preference is given to modifications in which the foil encompasses a mixture of poly(meth)acrylate and polyvinylidene fluoride in a ratio of from 1:0.15 to 1:0.40 (w/w), the ratio preferably being from 1:0.15 to 1:0.30 (w/w).

In another preferred variant, the inventive foil is a multilayer foil. This means that it has more than one sublayer, and the at least two sublayers differ from one another in the composition of the individual sublayer. One layer can therefore comprise PMMA, and another layer can comprise PVDF. The invention also includes all of the conceivable combinations, and for example one layer can comprise a blend composed of PMMA/PVDF while a second layer of the composite can comprise only PMMA or only PVDF. Further appropriate adjustment of properties can also be achieved by adding further layers composed of various materials.

Embodiments which feature at least two sublayers encompassed by the foil, at least one of which is composed of poly(meth)acrylate and at least one other of which is composed of polyvinylidene fluoride, are of very particular interest for a multilayer weathering-protection foil. Further preference is given to foils in which the foil is composed of two sublayers, of which one is a poly(methyl) methacrylate layer and the other is a polyvinylidene fluoride layer.

The foil composites mentioned composed of more than one sublayer are obtainable by foil-production processes known per se. In one preferred embodiment, the composites are obtainable by coextrusion. However, lamination processes are also conceivable, for example with or without the use of adhesion promoters.

Foil composites (multilayer foils) preferred are particularly those in which the PVDF foil itself acts as adhesion promoter, for example with respect to the substrates to be coated composed of, for example, PVC.

Other foil composites preferred are those in which both layers comprise a blend, in order to raise the adhesion to one another. By way of example, an exterior PMMA layer can comprise a subordinate proportion of PVDF in order to ensure good adhesion to a layer of pure PVDF. The PVDF layer in turn serves for direct contact with a substrate layer preferably comprising PVC.

The stabilizer package (light stabilizer)

Light stabilizers are well known and are described in detail by way of example in Hans Zweifel, Plastics Additives Handbook, Hanser Verlag, 5th Edition , 2001, p. 141 ff. Light stabilizers are understood to include UV absorbers, UV stabilizers and free-radical scavengers.

UV absorbers can by way of example derive from the group of the substituted benzophenones, salicylic esters, cinnamic esters, oxanilides, benzoxazinones, hydroxyphenylbenzotriazoles, triazines or benzylidenemalonate.

The best-known representatives of the UV stabilizers/free-radical scavengers are provided by the group of the sterically hindered amines (hindered amine light stabilizer, HALS).

The inventive stabilizer package is composed of the following components:
component A: a UV absorber of benzotriazole type,
component B: a UV absorber of triazine type,
component C: a UV stabilizer (HALS compound).

The individual components can be used in the form of an individual substance or in a mixture.

Intrapolymerizable UV Absorbers

Typical monomers of this type contain groups with high absorption in the wavelength range from 290 to 370 nm. Preference is given to monomers whose UV absorption in the form of a layer of thickness 5 mm of a solution in chloroform (spectroscopic quality) at a concentration of 0.002% by weight is at least 10%. Examples of suitable compounds are derivatives of 2-hydroxy-benzophenone, of hydroxyacetophenone, of cyano-13,3-biphenyl, of hydroxybenzoic esters, of oxanilide, of p-aminobenzoic esters or of the 6,8-dialkyl-4-oxo-5-chromanyl group. The ethylenically unsaturated groups which are present in these monomers and which are capable of free-radical polymerization are preferably acrylic, methacrylic, allyl or vinyl groups.

Examples of suitable monomers are: 2-(cyano-β,β-biphenylacryloyloxy)ethyl-1 methacrylate, 2-(2′-hydroxy-3′-methacrylamidomethyl-5′-octylphenyl)benzo-triazole, 2-hydroxy-4-(2-hydroxy-3-methacryloyloxy)propoxybenzophenone, 2-(alpha-cyano-β,β-biphenylacryloyloxy)ethyl-2-methacrylamide, 2-hydroxy-4-methacryloyloxybenzophenone, 2-hydroxy-4-acryloyloxyethyloxy-benzophenone, N-(4-methacryloylphenol)-N′-(2-ethylphenyl)oxamide, vinyl 4-ethyl-alpha-cyano-β-phenylcinnamate, 2-(2-hydroxy-5-vinylphenyl)-2-benzo-triazole.

The selected proportion of the UV-absorbing monomers in the polymethyl methacrylate can advantageously be sufficiently high that the foil layer absorbs at least 98% of the incident UV radiation whose wavelength is from 290 to 370 nm. The concentration required for this depends on the layer thickness and on the effectiveness of the monomer. It is generally from 0.1% by weight to 2% by weight, based on the weight of the monomers used for preparation of the polymethyl (meth)acrylates.

Intrapolymerizable UV absorbers have the disadvantage of not migrating. During the course of weathering, the upper layer exposed to UV light and weathering becomes increasingly depleted in UV absorber, but no unused UV absorber can diffuse to replace it because the molecule has been immobilized as a constituent of the polymer, and the layer is unprotected from the attacks of UV radiation and weathering.

In contrast, the use of non-intrapolymerized UV absorbers permits consequent migration of the UV absorber to the surface. At the same time, however, it is desirable to avoid escape of the migratory UV absorber from the plastics moulding during processing, e.g. by extrusion. Preference is therefore given here to the use of involatile light stabilizers. Volatility can be determined by way of the weight loss in TGA to DIN ISO 11358. Preference is given here to light stabilizers which, when this test is carried out on the pure substance with a heating rate of 20° C./min in air, exhibit a weight loss of 2% at a temperature above 240° C., preferably above 270° C. and particularly preferably greater than 300° C.

Component A: UV Absorber of Benzotriazole Type

Examples of UV absorbers of benzotriazole type that can be used are 2-(2-hydroxy-5-methylphenyl)benzotriazole, 2-[2-hydroxy-3,5-di(alpha,alpha-dimethylbenzyl)phenyl]benzotriazole, 2-(2-hydroxy-3,5-di-tert-butyl-phenyl)benzotriazole, 2-(2-hydroxy-3,5-butyl-5-methylphenyl)-5-chloro-benzotriazole, 2-(2-hydroxy-3,5-di-tert-butylphenyl)-5-chlorobenzotriazole, 2-(2-hydroxy-3,5-di-tert-amylphenyl)benzotriazole, 2-(2-hydroxy-5-tert-butyl-phenyl)benzotriazole, 2-(2-hydroxy-3-sec-butyl-5-tert-butylphenyl)benzotriazole and 2-(2-hydroxy-5-tert-octylphenyl)benzotriazole, phenol, 2,2′-methylenebis[6-(2H-benzotriazol-2-yl)-4-(1,1,3,3-tetramethylbutyl)].

The amounts used of the UV absorbers of benzotriazole type are from 0.1% by weight to 10% by weight, preferably from 0.2% by weight to 6% by weight and very particularly preferably from 0.5% by weight to 4% by weight, based on the weight of the monomers used to prepare the polymethyl (meth)acrylates. It is also possible to use mixtures of different UV absorbers of benzotriazole type.

Component B: UV Absorber of Triazine Type

Triazines, such as 2-(4,6-diphenyl-1,3,5-triazin-2-yl)-5-hexyloxyphenol, can moreover also be used as UV stabilizers in the mixture.

The amounts used of the triazines are from 0.0% by weight to 5% by weight, preferably from 0.2% by weight to 3% by weight and very particularly preferably from 0.5% by weight to 2% by weight, based on the weight of the monomers used to prepare the polymethyl (meth)acrylates. It is also possible to use mixtures of different triazines.

Component C: UV Stabilizers

An example which may be mentioned here for free-radical scavengers/UV stabilizers is sterically hindered amines, known as HALS (Hindered Amine Light Stabilizer). They can be used to inhibit ageing phenomena in paints and plastics, especially in polyolefin plastics (Kunststoffe, 74 (1984) 10, pp. 620-623; Farbe +Lack, Volume 96, 9/1990, pp. 689-693). The tetramethylpiperidine group present in the HALS compounds is responsible for the stabilizing effect. This class of compound can have no substitution on the piperidine nitrogen or else substitution by alkyl or acyl groups on the piperidine nitrogen. The sterically hindered amines do not absorb in the UV region. They scavenge free radicals that have been formed, whereas the UV absorbers cannot do this. Examples of HALS compounds which have stabilizing effect and which can also be used in the form of mixtures are: bis(2,2,6,6-tetramethyl-4-piperidyl) sebacate, 8-acetyl-3-dodecyl-7,7,9,9-tetramethyl-1,3,8-triazaspiro(4,5)-decane-2,5-dione, bis(2,2,6,6-tetramethyl-4-piperidyl) succinate, poly(N-β-hydroxyethyl-2,2,6,6-tetramethyl-4-hydroxypiperidine succinate) or bis(N-methyl-2,2,6,6-tetramethyl-4-piperidyl) sebacate.

The amounts used of the HALS compounds are from 0.0% by weight to 5% by weight, preferably from 0.1% by weight to 3% by weight and very particularly preferably from 0.2% by weight to 2% by weight, based on the weight of the monomers used to prepare the polymethyl (meth)acrylates. It is also possible to use mixtures of different HALS compounds.

Other costabilizers that can be used moreover are the HALS compounds described above, disulphites, such as sodium disulphite, and sterically hindered phenols and phosphites.

Further Additives

Further additives which can be added to the plastics moulding are matting agents, pigments, dyes or adhesion promoters.

Production of the Foils

The inventive foil can be produced at any desired thickness as a function of the intended application. A surprising factor here is always the high transparency of >91.5%, paired with exceptional weathering resistance and also with the very high weathering protection provided to the substrate. However, for the purposes of the invention preference is given to a relatively thin plastics moulding, namely a film or a foil, characterized by a thickness in the range from 10 to 200 μm, preferably in the range from 40 to 120 μm, particularly preferably in the range from 50 to 90 μm.

The single- or multilayer foil is produced by methods known per se, examples being extrusion through a slot die, as in flat-film extrusion, or blown-film extrusion, or solution casting. Multilayer plastic foils can by way of example be produced by coextrusion or lamination or by extrusion coating.

One particular production variant relates to a transparent foil composed of plastic providing increased weathering resistance and improved intrinsic stability, in which process

a foil is moulded in the chill-roll process from a composition encompassing

a) poly(meth)acrylate and polyvinylidene fluoride in a ratio of from 1:0.01 to 1:1 (w/w); and

b) a mixture composed of UV stabilizers and of UV absorbers.

Another particular modification of the process relates to the production of a transparent multi-sublayer foil composed of plastic with increased weathering resistance and with improved intrinsic stability, in which process

a poly(meth)acrylate foil and a polyvinylidene fluoride foil are coextruded or laminated to one another, where one or both of the foils comprise(s) a mixture composed of UV stabilizers and of UV absorbers, or where one of the foils comprises at least one UV stabilizer and the other foil comprises at least one UV absorber, and where the laminated or coextruded multi-sublayer foil comprises the poly(meth)acrylate and polyvinylidene fluoride in a ratio of from 1:0.01 to 1:1 (w/w).

The inventive foils have a broad range of applications. One preferred use of the foils is the coating of plastics mouldings. Here, it is particularly advantageous to coat plastics mouldings which comprise PVC, or plastics mouldings which are composed of polyvinyl chloride. The protected substrate is advantageously by way of example a window profile composed of aluminium, of wood, of plastic or of a composite material, which by this stage bears a decorative foil, preferably composed of PVC. This foil is then protected from weathering by using the inventive foil.

Another preferred use of the inventive foil consists in the design of a high-specification, durable surface finish for substrate materials.

Application of the inventive foil to the substrate is in all cases relatively simple. The foil is preferably applied by means of coextrusion to the material to be protected. Application of the foil by means of foil lamination to the material to be protected is also preferred. Preference is also given to a use which is characterized in that the film is applied by means of extrusion coating to the material to be protected.

### EXAMPLES

Composition for the examples:

### Example 1

A PMMA foil of thickness 56 μm is used, composed of

a) 89.8% by weight of a polymer composed of a two-phase impact modifier according to EP 0 528 196 whose overall composition is

| | |
|---|---|
| 59.9% by weight | of MMA |
| 37.1% by weight | of butyl acrylate |
| 0.36% by weight | of ethyl acrylate |
| 0.66% by weight | of allyl methacrylate |
| 1.95% by weight | of 3-(2-benzotriazololyl) 2-hydroxy-5- |
| | tert-octylbenzylmethacrylate, an intra- |
| | polymerizable UV absorber. |
| 0.53% by weight | of dodecylmercaptan, based on the |
| | above monomers, |

b) 10% by weight of PLEXIGLAS® 7H, obtainable from Röhm GmbH,

c) 0.2% by weight of Tinuvin 360 (UV absorber based on benzotriazole from Ciba SC)

and this mixture is extruded by means of conventional processes to give a foil.

The foil is then laminated to a decorative PVC foil (brown wood decorative effect), then applied to a plastics backing and tested.

Composition for further examples:

### Example 2

Example 1, minus 1.95% by weight of 3-(2-benzotriazololyl) 2-hydroxy-5-tert-octylbenzylmethacrylate in the polymer+2.3% by weight, based on the foil according to Example 1, of Tinuvin® 360. The amounts of monomer of Example 1 are to be adjusted accordingly.

### Example 3

Example 1, minus 1.95% by weight of 3-(2-benzotriazololyl) 2-hydroxy-5-tert-octylbenzylmethacrylate in the polymer+2.3% by weight, based on the foil according to Example 1, of Tinuvin® 360 +0.4% by weight of Chimassorb 119 (HALS from Ciba SC). The amounts of monomer of Example 1 are to be adjusted accordingly.

### Example 4

Example 1, minus 1.95% by weight of 3-(2-benzotriazololyl) 2-hydroxy-5-tert-octylbenzylmethacrylate+0.75% by weight of CGX UVA 006 (UV absorber from Ciba SC based on triazine), based on the foil according to Example 1+0.8% by weight of Tinuvin® 360. The amounts of monomer of Example 1 are to be adjusted accordingly.

### Example 5

Example 1, minus 1.95% by weight of 3-(2-benzotriazololyl) 2-hydroxy-5-tert-octylbenzylmethacrylate+0.75% by weight of CGX UVA 006, based on the foil according to Example 1+0.4% by weight of Chimassorb 119+0.8% by weight of Tinuvin® 360. The amounts of monomer of Example 1 are to be adjusted accordingly.

### Example 6

Example 1, minus 1.95% by weight of 3-(2-benzotriazololyl) 2-hydroxy-5-tert-octylbenzylmethacrylate+0.6% by weight of CGX UVA 006, based on the foil according to Example 1+0.4% by weight of Chimassorb 119+1.1% by weight of Tinuvin® 360. The amounts of monomer of Example 1 are to be adjusted accordingly.

### Example 7

Commercially available foil, producer: Cova

### Example 8

Foil analogous to Example 1, but the foil is laminated to a red decorative PVC foil, and then applied to a plastics backing and tested.

### Example 9

Foil analogous to Example 3, but the foil is laminated to a red decorative PVC foil, and then applied to a plastics backing and tested.

### Example 10

Foil analogous to Example 5, but the foil is laminated to a red decorative PVC foil, and then applied to a plastics backing and tested.

The foils produced were weathered in the ISO 4892-2 xenotest. The intensity of the radiation was 180 watts/m², at wavelengths from 300 to 400 nm.

### Example 11

Name of moulding composition: Plex 8943-F (ex production plant, obtainable from Röhm GmbH)

Regulator content (dodecyl mercaptan): 0.79% by weight

Proportion of butyl acrylate: 8% by weight

Result:

Following 4000 h of weathering in an Alpha High Energy accelerated-weathering device from Atlas, the following results were determined with regard to protective action (e.g. colour change) for the underlying substrate (decorative wood effect) by means of optical evaluation of the samples by a group of experts:

The protective action of the moulding composition from Example 11 is comparable with the benchmark (identically produced sample using protective PMMA foil from the competitor Kaneka).

### Example 12

Name of moulding composition: Experimental product 1 (ex production plant, obtainable from Röhm GmbH)

Regulator content (dodecyl mercaptan): 0.59% by weight

Proportion of butyl acrylate: 8% by weight.

### Example 13

Name of moulding composition: Experimental product 2 (ex production plant, obtainable from Röhm GmbH)

Regulator content (dodecyl mercaptan): 0.59% by weight

Proportion of butyl acrylate: 12% by weight.

The foils produced from moulding compositions of Examples 12 and 13 exhibited markedly better behaviour when assessed visually (grade: ++)

| | Colour change | Mattness | Colour change | Mattness |
|---|---|---|---|---|
| | (visual | (visual | (visual | (visual |
| | assessment | assessment | assessment | assessment |
| Example | after 4000 h | after 4000 h) | after 5333 h | after 5333 h) |
| 1: | − | − | −− | −− |
| 2: | ◯ | ◯ | − to −− | − |
| 3: | ◯ | ++ | ◯ | + |
| 4: | ◯ | ++ | ◯ | + |
| 5: | + | ++ | + | ++ |
| 6: | + | ++ | + | + to ++ |
| 7: | − | ◯ | −− | −− |
| 8: | − | − | −− | −− |
| 9: | ◯ | ++ | ◯ | + |
| 10: | ++ | ++ | ++ | ++ |

++ = no visible alteration
+ = only very slight alteration visible
◯ = only slight alteration visible
− = marked alteration visible
−− = very marked alteration

1. A transparent foil composed of plastic with improved weathering resistance and increased intrinsic stability comprising
a) poly(meth)acrylate and polyvinylidene fluoride in a ratio of from 1:0.01 to 1:1 (w/w);
and
b) a mixture composed of UV stabilizers and of UV absorbers.

2. The foil according to claim 1,
wherein
the foil is a single-layer foil.

3. The foil according to claim 2,
wherein
the foil comprises a mixture of poly(meth)acrylate and polyvinylidene fluoride in a ratio of from 1:0.1 to 1:0.5 (w/w).

4. The foil according to claim 1,
wherein
the foil is a multilayer foil.

5. The foil according to claim 4,
wherein
the foil comprises at least two sublayers, of which at least one is composed of poly(meth)acrylate and at least one other is composed of polyvinylidene fluoride.

6. The foil according to claim 5,
wherein
the foil is composed of two sublayers, of which one is a poly(methyl) methacrylate layer and the other is a polyvinylidene fluoride layer.

7. The foil according to claim 4,
wherein
it has been coextruded.

8. The foil according to claim 1,
wherein
its transparency is >91.5%.

9. The foil according to claim 1,
wherein
the weight-average molar mass MM of the poly(meth)acrylate a) is ≧80 000 g/mol, determined by means of gel permeation chromatography against PMMA calibration standards.

10. The foil according to claim 1,
wherein
the weight-average molar mass MM of the poly(meth)acrylate a) is ≧120 000 g/mol, determined by means of gel permeation chromatography against PMMA calibration standards.

11. The foil according to claim 1,
wherein
the weight-average molar mass MM of the poly(meth)acrylate a) is ≧150 000 g/mol, determined by means of gel permeation chromatography against PMMA calibration standards.

12. The foil according to claim 1,
wherein
the weight-average molar mass MM of the poly(meth)acrylate a) is in the range from 80 000 g/mol to 180 000 g/mol, in each case determined by means of gel permeation chromatography against PMMA calibration standards.

13. The foil according to claim 1,
wherein
the poly(meth)acrylate a) is obtained by polymerization of a composition whose polymerizable constituents comprise:
a. from >50% by weight to 99.9% by weight of methyl methacrylate,
b. from 0.1% by weight to <50% by weight of an acrylate having an ester radical deriving from a C1-C4 alcohol, and
c. from 0% by weight to 10% by weight of monomers copolymerizable with the monomers a. and b.

14. The foil according to claim 1,
wherein
the poly(meth)acrylate a) is obtained by polymerization of a composition whose polymerizable constituents comprise:
a. from 88% by weight to 92% by weight of methyl methacrylate,
b. from 8% by weight to 12% by weight of an acrylate having an ester radical deriving from a C1-C4 alcohol, and
c. from 0% by weight to 10% by weight of monomers copolymerizable with the monomers a. and b.

15. The foil according to claim 1,
wherein
the poly(meth)acrylate a) has been rendered impact-resistant by using an impact modifier.

16. The foil according to claim 1,
wherein
the amount of impact modifier is from 1% to 50% by weight, based on the entirety of poly(meth)acrylate and impact modifier.

17. The foil according to claim 15,
wherein
the poly(meth)acrylate a) and the impact modifier derive from a core-shell polymer, where the shell forms a matrix composed of polymer in the foil.

18. The foil according to any of the preceding claim 1,
wherein
the mixture composed of UV stabilizers and of UV absorbers is composed of the following substances:
the UV absorbers of benzotriazole type, used in amounts of from 0.1% by weight to 10% by weight, the UV absorbers of triazine type, used in amounts of from 0.0% by weight to 5% by weight, and
the HALS compounds, used in amounts of from 0.0% by weight to 5% by weight.

19. The foil according to claim 18,
wherein
the mixture composed of UV stabilizers and of UV absorbers is composed of the following substances:
the UV absorbers of benzotriazole type, used in amounts of from 0.2% by weight to 6% by weight,
the UV absorbers of triazine type, used in amounts of from 0.2% by weight to 3% by weight, and
the HALS compounds, used in amounts of from 0.1% by weight to 3% by weight.

20. The foil according to claim 19,
wherein
the mixture composed of UV stabilizers and of UV absorbers is composed of the following substances:
the UV absorbers of benzotriazole type, used in amounts of from 0.5% by weight to 4% by weight,
the UV absorbers of triazine type, used in amounts of from 0.5% by weight to 3% by weight, and
the HALS compounds, used in amounts of from 0.2% by weight to 2% by weight.

21. The foil according to any of the preceding claim 1,
having a thickness in the range from 10 to 200 μm.

22. A process for the production of a transparent foil composed of plastic providing increased weathering resistance and improved intrinsic stability comprising
moulding a foil in the chill-roll process from a composition comprising
a) poly(meth)acrylate and polyvinylidene fluoride in a ratio of from 1:0.01 to 1:1 (w/w);
and
b) a mixture composed of UV stabilizers and of UV absorbers.

23. A process for the production of a transparent multi-sublayer foil composed of plastic with increased weathering resistance and with improved intrinsic stability,
comprising
coextruding or laminating to one another a poly(meth)acrylate foil and a polyvinylidene fluoride foil, where one or both of the foils comprise(s) a mixture composed of UV stabilizers and of UV absorbers, or where one of the foils comprises at least one UV stabilizer and the other foil comprises at least one UV absorber, and where the laminated or coextruded multi-sublayer foil comprises a poly(meth)acrylate and a polyvinylidene fluoride in a ratio of from 1:0.01 to 1:1 (w/w).

24. A coating of plastics mouldings comprising the foil according to claim 1.

25. The coating according to claim 24, wherein the coated plastics moulding is composed of polyvinyl chloride.

26. A design of a high-specification, durable surface finish for substrate materials comprising the foil according to claim 1.

27. The coating according to claim 24, wherein coextrusion is used to apply the foil to the material to be protected.

28. The coating according to claim 24, wherein foil lamination is used to apply the foil to the material to be protected.

29. The coating according to claim 24, wherein extrusion coating is used to apply the foil to the material to be protected.
